(19) United States
(12) Patent Application Publication
(10) Pub. No.: US 2021/0173218 A1
(43) Pub. Date: Jun. 10, 2021

(54) IMAGE DISPLAY SYSTEM

(71) Applicant: MURAKAMI CORPORATION, Shizuoka (JP)

(72) Inventor: Masataka HAMANO, Shizuoka (JP)

(73) Assignee: MURAKAMI CORPORATION, Shizuoka (JP)

(21) Appl. No.: 16/759,082

(22) PCT Filed: Oct. 4, 2018
(86) PCT No.: PCT/JP2018/037272

§ 371 Date: Apr. 24, 2020

(30) Foreign Application Priority Data
Nov. 1, 2017 (JP) 2017-212293

(51) Int. Cl. G02B 27/01; B60K 35/00; G02B 27/00

(52) U.S. Cl. CPC G02B 27/0179; B60K 35/00; B60K 2370/741; G02B 2027/0187; B60K 2370/1529; G02B 27/0093

(57) ABSTRACT

An image display system includes a first display device and a second display device, each of which displays an image. The image display system further includes an optical imaging member that forms an aerial image displayed in each of the first display device and the second display device in respective positions different from each other. Light of an image displayed in the first display device passes through the first reflectance switching element and is then made incident on the optical imaging member, to thereby form the image of interest in the air. Light of an image displayed in the second display device is reflected by the first reflectance switching element and is then made incident on the optical imaging member, to thereby form the image of interest in the air.

### CROSS REFERENCE TO RELATED APPLICATION

This application is a National Stage Application of PCT/JP2018/037272, filed on Oct. 4, 2018, and which application is incorporated herein by reference. To the extent appropriate, a claim of priority is made to the above disclosed application.

### TECHNICAL FIELD

The present invention relates to an image display system.

### BACKGROUND ART

Patent Document 1 discloses a floating image display device that includes a mirror, a half mirror, and a pair of display sections disposed at respective distances different from each other with respect to the mirror. A background image displayed in one of the display sections nearer to the half mirror: passes through the half mirror; and is displayed by the mirror in a position nearer to the mirror (in a position farther from a user). A foreground image displayed in the other display section farther from the half mirror: is reflected by the half mirror; and is displayed by the mirror in a position farther from the mirror (in a position nearer to the user).

### RELATED ART DOCUMENT

### Patent Document

Patent Document 1: Japanese Patent No. 5,143,898

### SUMMARY OF THE INVENTION

### Problems to be Solved by the Invention

In the technique disclosed in Patent Document 1, usage of the half mirror may cause loss of light intensity of image light by the display section, resulting in a possible decrease in visibility of an aerially displayed image. On the other hand, in order to secure visibility of the image, it is necessary to display the image with high luminance, which may increase cost. Also, when a display which can provide such a high-luminance image is used, it is necessary to control a rise in temperature in a system of interest.

In light of the above-described problems, the present invention has been made in an attempt to provide an image display system that can form an aerial image in a plurality of positions different from each other, while keeping down loss of light intensity.

### Means for Solving the Problem

An image display system includes: a first display device and a second display device, each of which displays an image; an optical imaging member that is disposed spaced apart from each of the first display device and the second display device and that forms respective images displayed in the first display device or the second display device, in respective positions different from each other; and a reflectance switching element that is switchable between a transmission state and a reflection state. Light of the image displayed in the first display device passes through the reflectance switching element and is then made incident on the optical imaging member, to thereby form the image of interest in the air. Light of the image displayed in the second display device is reflected by the reflectance switching element and is then incident on the optical imaging member, to thereby form the image of interest in the air.

### Advantageous Effects of the Invention

In the present invention, an aerial image can be formed in a plurality of positions different from each other, while keeping down loss of light intensity.

### BRIEF DESCRIPTION OF THE DRAWINGS

FIG. 1 is a side diagram schematically illustrating an image display system according to a first embodiment of the present invention.

FIG. 2 is a block diagram illustrating the image display system according to the first embodiment of the present invention.

FIG. 3A to FIG. 3D are each a diagram for explaining an example of how the image display system works according to the first embodiment of the present invention.

FIG. 4 is a side diagram schematically illustrating an image display system according to a second embodiment of the present invention.

FIG. 5 is a block diagram illustrating the image display system according to the second embodiment of the present invention.

FIG. 6 is a side diagram schematically illustrating an image display system according to a third embodiment of the present invention.

FIG. 7 is a block diagram illustrating the image display system according to the third embodiment of the present invention.

FIG. 8A to FIG. 8C are each a diagram for explaining an example of how the image display system works according to the third embodiment of the present invention.

### EMBODIMENTS FOR CARRYING OUT THE INVENTION

Embodiments of the present invention are described in detail with reference to related drawings. In the explanation, same reference numerals are given to same elements, and description thereof is omitted herefrom.

### First Embodiment

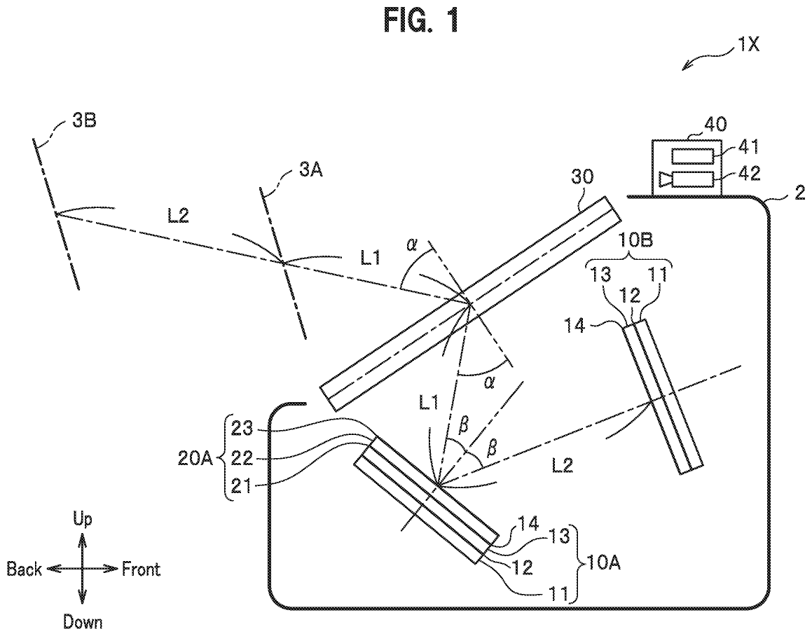

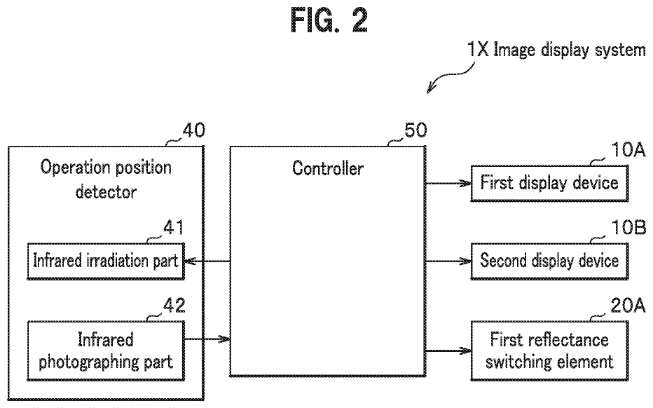

As illustrated in FIG. 1 and FIG. 2, an image display system 1X according to a first embodiment of the present invention includes: a first display device 10A; a second display device 10B; a first reflectance switching element 20A; an optical imaging member 30; an operation position detector 40; and a controller 50.

### <First Display System>

The first display device 10A is housed in a housing 2 and displays an image 3A under control of the controller 50. The first display device 10A is oriented upward and forward and is disposed below the optical imaging member 30. In this embodiment, the first display device 10A: is an LCD (Liquid Crystal Display); and includes a backlight 11, an absorptive polarizer 12, a liquid crystal cell 13, and another absorptive polarizer 14.

### <Backlight>

The backlight 11 is an area light source composed of white light and is switchable between a lit state and an unlit state under control of the controller 50. In the lit state, the backlight 11 emits white light forward and upward.

### <<Absorptive Polarizer>>

The absorptive polarizer 12 is disposed directly on top of an upper surface (a light-emitting surface) of the backlight 11. The absorptive polarizer 12: lets light oscillating in a longitudinal direction (an up-and-down direction (a front-back direction)) pass through; and absorbs light oscillating in a transverse direction (a crosswise direction) which is perpendicular to the longitudinal direction. That is, a light transmission axis of the absorptive polarizer 12 is set in the longitudinal direction. Note that absorption of light in each of the absorptive polarizers 12, 14, 23 is not limited to a 100% absorption of light oscillating in a direction of interest. The absorption used herein may include absorption allowing, for example, an about 10% light transmittance.

### <<Liquid Crystal Cell>>

The liquid crystal cell 13 is disposed directly on a top surface of the absorptive polarizer 12. The liquid crystal cell 13: is made up of a plurality of pixels; and emits an image light for displaying an image, using the white light emitted from the backlight 11. The first display device 10A can switch each of the pixels between: a transmittance state in which light oscillating in the longitudinal direction is passed therethrough; and a blocking state in which the light oscillating in the longitudinal direction is blocked, under control by the controller 50.

The liquid crystal cell 13 is suitably realized by, for example, an IPS (In-Plane-Switching) liquid crystal cell. If the liquid crystal cell 13 is of IPS type, the liquid crystal cell 13: blocks light when no voltage is applied; and passes light therethrough when voltage is applied. Unlike a liquid crystal cell 22 of type TN (Twisted Nematic) to be described later, the IPS liquid crystal cell 13 can realize a suitable light transmittance property in any visually recognizable directions.

### <<Another Absorptive Polarizer>

Another absorptive polarizer 14 is disposed directly on top of an upper surface (a light-emitting surface) of the liquid crystal cell 13. The absorptive polarizer 14: lets light oscillating in the longitudinal direction pass through; and absorbs light oscillating in the transverse direction which is perpendicular to the longitudinal direction. That is, a light transmission axis of the absorptive polarizer 14 is set in the longitudinal direction same as that of the absorptive polarizer 12.

### <Second Display System>

The second display device 10B is housed in the housing 2 and displays an image 3B under control of the controller 50. The second display device 10B is oriented downward and backward and is disposed in front of the first reflectance switching element 20A.

In this embodiment, the second display device 10B; is an LCD (Liquid Crystal Display); and, similarly to those of the first display device 10A, includes a backlight 11, an absorptive polarizer 12, a liquid crystal cell 13, and another absorptive polarizer 14.

### <First Reflectance Switching Element>

A first reflectance switching element (a mirror optical element) 20A is housed in the housing 2 and, in this embodiment, is disposed on a side nearer to a display surface (a top surface) of the first display device 10A. The first reflectance switching element 20A is an element which can electrically switch a state thereof between a reflection state (reflectance: high) and a transmission state (reflectance: low) to be described hereinafter, under control of the controller 50. The first reflectance switching element 20A may be firmly attached to the first display device 10A, using optical coupling resin, tape, or the like. Alternatively, the first reflectance switching element 20A may be disposed spaced apart from the first display device 10A. The first reflectance switching element 20A includes a reflective polarizer 21, a liquid crystal cell 22, and an absorptive polarizer 23, in this order from lower to upper.

### <<Reflective Polarizer>>

The reflective polarizer 21 is disposed on a side nearer to the display surface of the first display device 10A, that is, on a side nearer to a top surface of the absorptive polarizer 14. The reflective polarizer 21 lets light oscillating in the longitudinal direction pass through; and reflects light oscillating in the transverse direction which is perpendicular to the longitudinal direction. That is, a light transmission axis of the reflective polarizer 21 is set in the longitudinal direction. Note that reflection of light on the reflective polarizer 21 is not limited to a 100% reflection of light oscillating in a direction of interest. The reflection used herein may include reflection allowing, for example, an about 10% transmittance and absorbance.

### <<Liquid Crystal Cell>>

The liquid crystal cell 22 is disposed directly on top of an upper surface (on a display surface side) of the reflective polarizer 21. The liquid crystal cell 22 is of TN (Twisted Nematic) type. The liquid crystal cell 22 includes: a pair of transparent substrates (for example, glass) disposed back and front; an oriented film disposed on each of the transparent substrates; and liquid crystal sealed between the transparent substrates with the respective oriented films disposed thereon. Liquid crystal is disposed between a pair of the oriented films having been subjected to so-called rubbing, and molecules of the liquid crystal arrange themselves in a 90-degrees twisted helical structure from one transparent substrate to the other transparent substrate.

Liquid crystal has optical rotation when no voltage is applied thereto. That is, in the voltage-off state, the liquid crystal converts light oscillating in the longitudinal direction which passes from a side nearer to the absorptive polarizer 23 to a side nearer to the reflective polarizer 21, into light oscillating in the transverse direction. Also, in the voltage-off state, the liquid crystal converts light oscillating in the transverse direction which has been reflected by the reflective polarizer 21, into light oscillating in the longitudinal direction, when the light passes from the side nearer to the reflective polarizer 21 to the side nearer to the absorptive polarizer 23.

When voltage is applied, the liquid crystal loses the nature of optical rotation (lets light travel straight) due to a change in arrangement of molecules of the liquid crystal. That is, in the voltage-on state, the liquid crystal lets light oscillating in the longitudinal direction pass through, keeping the light oscillating in the longitudinal direction as it is.

### <<Absorptive Polarizer>>

The absorptive polarizer 23 is disposed directly on top of an upper surface (on a display surface side) of the liquid crystal cell 22. The absorptive polarizer 23 lets light oscillating in the longitudinal direction pass through; and absorbs light oscillating in the transverse direction which is perpendicular to the longitudinal direction. That is, a light transmission axis of the absorptive polarizer 23 is set in the longitudinal direction.

### <Switching Between Reflection State and Transmission State of First Reflectance Switching Element>

The first reflectance switching element 20A takes a reflection state under normal conditions (liquid crystal cell 22: in the voltage-off state). In the reflection state, the liquid crystal cell 22 converts light oscillating in the longitudinal direction from the side nearer to the absorptive polarizer 23, into light oscillating in the transverse direction, which is then reflected by the reflective polarizer 21. The liquid crystal cell 22 convers the light oscillating in the transverse direction reflected by the reflective polarizer 21, into light oscillating in the longitudinal direction, which exits from the absorptive polarizer 23. In the reflection state, the absorptive polarizer 23 absorbs light oscillating in the transverse direction from the side nearer to the absorptive polarizer 23. Also in the reflection state, light oscillating in the longitudinal direction from the side nearer to the reflective polarizer 21; passes through the reflective polarizer 21; is converted into light oscillating in the transverse direction by the liquid crystal cell 22; and is absorbed by the absorptive polarizer 23. As described above, in the reflection state, the light from the side nearer to the reflective polarizer 21 will not pass through the first reflectance switching element 20A and, obviously, will not exit upward. Therefore, even when the first display device 10A emits image light, the first reflectance switching element 20A can suitably serve as a mirror.

When the liquid crystal cell 22 is supplied with voltage, the first reflectance switching element 20A takes a light transmission state. In the transmission state, light oscillating in the longitudinal direction passes the first reflectance switching element 20A in both directions (from and to the side nearer to the reflective polarizer 21 to and from the side nearer to the absorptive polarizer 23). Also in the transmission state, the absorptive polarizer 23 absorbs light oscillating in the transverse direction from the side nearer to the absorptive polarizer 23.

### <Optical Imaging Member>

The optical imaging member 30 is a plate-shaped member; is housed in the housing 2; and forms an aerial image of the image 3A displayed in the first display device 10A or the image 3B displayed in the second display device 10B. The optical imaging member 30 is disposed spaced apart from the first display device 10A and the second display device 10B. The optical imaging member 30 can be suitably realized by using AI (Aerial Imaging) Plate (registered trademark; manufactured by Asukanet Co., Ltd., Japanese Patent No. 4865088), or the like. The optical imaging member 30 forms the image 3A displayed in the first display device 10A disposed on one side of the optical imaging member 30, on the other side thereof. Herein; a distance which an image light travels between the optical imaging member 30 and the formed image 3A is equal to a distance which an image light travels between the first display device 10A and the optical imaging member 30 (a first distance L1). A size of the formed image 3A is equal to a size displayed in the first display device 10A. Also, the optical imaging member 30 forms the image 3B displayed in the second display device 10B disposed on one side of the optical imaging member 30, at a position not corresponding to that of the image 3A, on the other side of the optical imaging member 30 of interest. Herein, a distance which an image light travels between the optical imaging member 30 and the formed image 3B is equal to a sum of the first distance L1, and a distance between the first reflectance switching element 20A and the second display device 10B, which is referred to as a distance L2 (a second distance L1+L2). A size of the formed image 3B is equal to that displayed in the second display device 10B. An attitude (a setting angle) of each of the first display device 10A, the second display device 10B, the first reflectance switching element 20A, and the optical imaging member 30 is set such that a user can visually recognize the formed images 3A, 3B in good condition. For example, the formed images 3A, 3B are displayed on an imaginary plane which is substantially perpendicular to the front-back direction.

### <Operation Position Detector>

The operation position detector 40: detects a position of an operation by a user (for example, a position of a user's finger); and includes an infrared irradiation part 41 and an infrared photographing part 42.

### <<Infrared Irradiation Part>>

The infrared irradiation part 41 irradiates an area in which the images 3A, 3B are formed, with infrared rays.

### <<Infrared Photographing Part>>

The infrared photographing part 42: is a stereo camera; and photographs the area in which the images 3A, 3B are formed, using the infrared rays irradiated by the infrared irradiation part 41. The infrared photographing part 42 outputs the photographed result to the controller 50.

### <Controller>

The controller 50 includes a CPU (Central Processing Unit), a ROM (Read-Only Memory), and a RAM (Random Access Memory). The controller 50 provides control over the first display device 10A, the second display device 10B, the first reflectance switching element 20A, and the infrared irradiation part 41, based on the result photographed by the infrared photographing part 42.

### <Example of how System Works>

Next is described an example of how the image display system 1X works regarding: forming and displaying the image 3A; forming and displaying the image 3B; and operations of displays, in this order.

### <<Forming and Displaying Image 3A>>

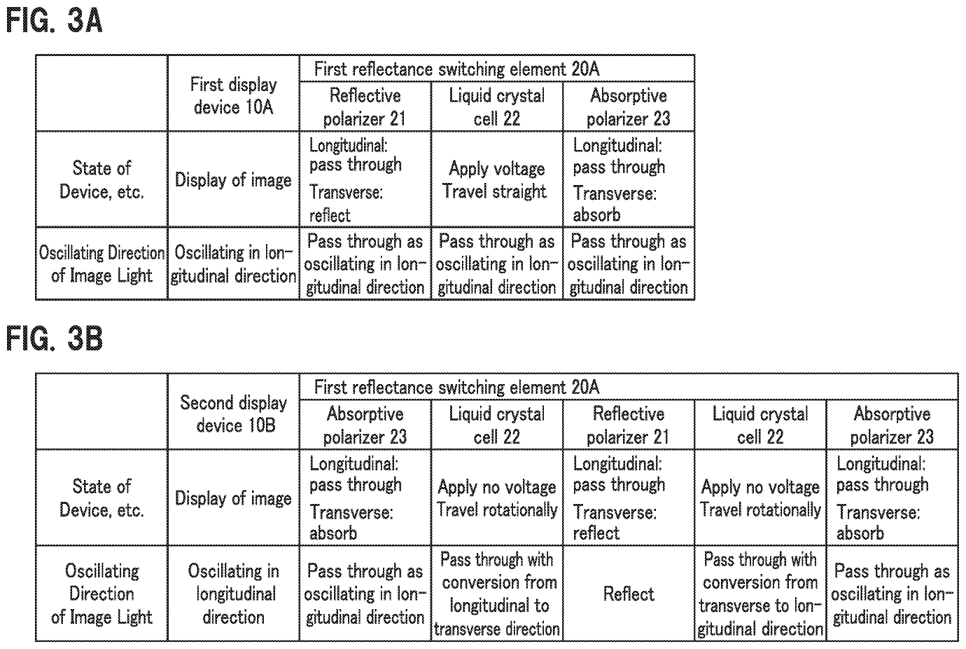

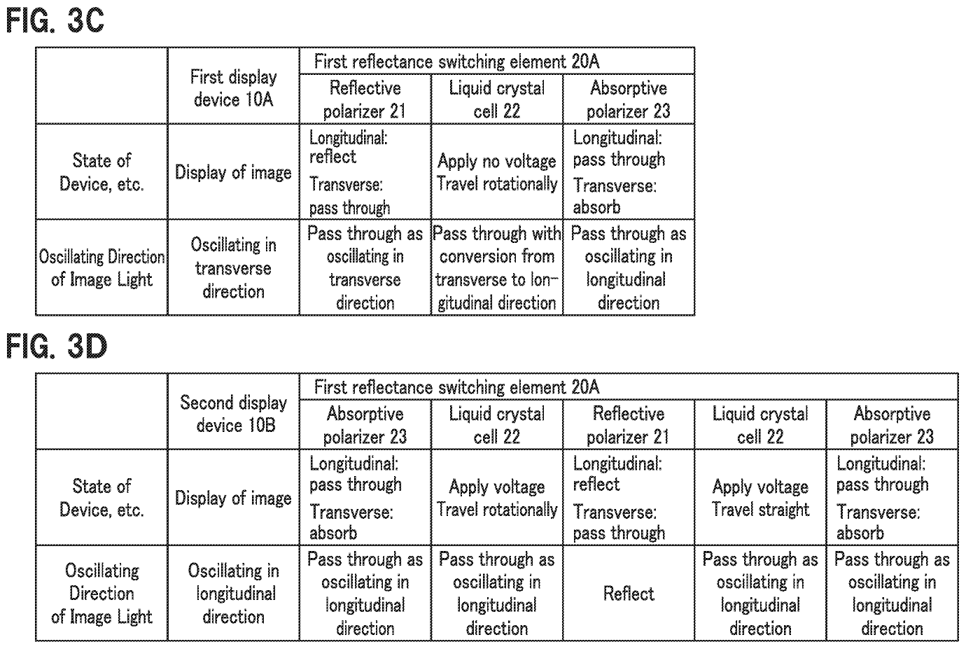

As illustrated in FIG. 3A, when the image 3A is formed and displayed, the controller 50: turns on the backlight 11 of the first display device 10A; and applies voltage to the liquid crystal cell 13 of the first display device 10A and the liquid crystal cell 22 of the first reflectance switching element 20A. Note that control of whether or not voltage is applied is actually provided not to the liquid crystal cell 13 itself but rather to each of pixels thereof. Description below is thus made regarding a state of a given pixel to which voltage is applied.

In the first display device 10A, from among light emitted from the backlight 11, the absorptive polarizer 12: absorbs light oscillating in the transverse direction; and lets light oscillating in the longitudinal direction pass therethrough. The light oscillating in the longitudinal direction having passed through the absorptive polarizer 12 passes through the liquid crystal cell 13 as it is (as the light oscillating in the longitudinal direction). The light oscillating in the longitudinal direction having passed through the liquid crystal cell 13 passes through the absorptive polarizer 14.

The light oscillating in the longitudinal direction having passed through the absorptive polarizer 14 passes through the reflective polarizer 21 of the first reflectance switching element 20A. The light oscillating in the longitudinal direction having passed through the reflective polarizer 21 passes through the liquid crystal cell 22 as it is (as the light oscillating in the longitudinal direction), The light oscillating in the longitudinal direction having passed through the liquid crystal cell 22: passes through the absorptive polarizer 23; and exits to the optical imaging member 30.

That is, in a state where voltage is applied, the first reflectance switching element 20A of the image display system 1X serves as a light transmission layer which lets light of the image 3A displayed in the first display device 10A pass through.

The optical imaging member 30 makes the image 3A via the first reflectance switching element 20A refracted at a refracting angle α; and forms the refracted image 3A at a distance L1 (a distance which an image light of interest travels) from the optical imaging member 30 in the air.

Note that, in forming and displaying the image 3A, the controller 50 may leave the image 3B displayed in the second display device 10B as it is or may turn off the second display device 10B.

### <<Forming and Displaying Image 3B>>

As illustrated in FIG. 3B, when the image 3B is formed and displayed, the controller 50: turns on the backlight 11 of the second display device 10B; applies voltage to the liquid crystal cell 13 of the second display device 10B; and applies no voltage to the liquid crystal cell 22 of the first reflectance switching element 20A.

In the second display device 10B, from among light emitted from the backlight 11, the absorptive polarizer 12: absorbs light oscillating in the transverse direction; and lets light oscillating in the longitudinal direction pass therethrough. The light oscillating in the longitudinal direction having passed through the absorptive polarizer 12 passes through the liquid crystal cell 13 as it is (as the light oscillating in the longitudinal direction). The light oscillating in the longitudinal direction having passed through the liquid crystal cell 13 passes through the absorptive polarizer 14.

The light oscillating in the longitudinal direction having passed through the absorptive polarizer 14 passes through the absorptive polarizer 23 of the first reflectance switching element 20A. The light oscillating in the longitudinal direction having passed through the absorptive polarizer 23 is, when passing downward through the liquid crystal cell 22, converted into light oscillating in the transverse direction. The light oscillating in the transverse direction having been converted by the liquid crystal cell 22 is reflected by the reflective polarizer 21 at a reflection angle β. The light having been reflected by the reflective polarizer 21 is, when passing upward through the liquid crystal cell 22, converted into light oscillating in the longitudinal direction by the liquid crystal cell 22. The light oscillating in the longitudinal direction having been converted by the liquid crystal cell 22: passes through the absorptive polarizer 23; and exits to the optical imaging member 30.

That is, in a state where no voltage is applied, the first reflectance switching element 20A of the image display system 1X serves as a mirror which reflects light of the image 3B displayed in the second display device 10B.

The optical imaging member 30 makes the image 3B via the first reflectance switching element 20A refracted at a refracting angle α; and forms the refracted image 3B at a distance L1+L2 (a distance which an image light of interest travels) from the optical imaging member 30 in the air.

Note that, in forming and displaying the image 3B, the controller 50 may leave the image 3A displayed in the first display device 10A as it is or may turn off the first display device 10A.

When the first reflectance switching element 20A serves as a mirror in a voltage-on state, operations as illustrated in FIGS. 3C and 3D as examples are performed, though detailed description is omitted herein. FIG. 3C illustrates an example of operations when the image 3A is formed and displayed. FIG. 3D illustrates an example of operations when the image 3B is formed and displayed.

### <<Operations of Images 3A, 3B>>

The controller 50: performs an image recognition processing to the result photographed by the infrared photographing part 42; and thereby recognizes a finger of a user (for example, an index finger). The controller 50 detects, based on the recognized result of the users finger, a position of the user's finger (a distance thereof from the optical imaging member 30 and a two-dimensional position in the formed image 3A (or 3B)). When the distance from the optical imaging member 30 to the user's finger is equal to a distance from the optical imaging member 30 to the formed image 3A (or 3B), the controller 50 provides control of modifying the image 3A (or 3B). For example, the controller 50 can change contents of the image 3A, based on a two-dimensional position of a user's finger in the formed image 3A. Similarly, the controller 50 can change contents of the image 3B, based on a two-dimensional position of a user's finger in the formed image 3B. Also, the controller 50 can form and display the image 3B having contents same as those of the image 3A and then discontinue displaying the image 3A, based on the two-dimensional position of the user's finger in the formed image 3A. Similarly, the controller 50 can form and display the image 3A having contents same as those of the image 3B and then discontinue displaying the image 3B, based on a two-dimensional position of the user's finger in the formed image 3B. In the above-described display changing technique, the controller 50 previously stores therein a relationship between a two-dimensional position of a user's finger and contents of switched images. The controller 50 can form an image having contents desired by a user at a position desired by the user, using the detected two-dimensional position of the user's finger and the stored relationship.

The image display system 1X can be installed in a front end portion in a vehicle length direction of a vehicle compartment and a middle portion in a vehicle width direction thereof. In this case, the image display system 1X: can form and display the image 3A in such a position that can be operated by a driver sitting in a driver's seat or an occupant sitting in a front passenger seat; and can form and display the image 3B in such a position that can be operated by an occupant sitting in a back passenger seat.

The image display system 1X according to the first embodiment of the present invention uses not a half mirror but the first reflectance switching element 20A. This makes it possible to form an image in aerial positions different from each other, while keeping down loss of light intensity. In other words, the image display system 1X can switch image forming and displaying positions from among a plurality of positions having distances different from each other with respect to the optical imaging member 30 (in this embodiment, two different positions). Also, the image display system 1X can reduce a rise in temperature in the system 1X, because there is no need to use a high-luminance display device. The image display system 1X: can thus eliminate need for space, a device, or the like to reduce a rise in temperature; and can realize reduction in size and cost and improvement of reliability.

The system 1X includes the operation position detector 40, and thus, an aerially formed image can be used as a touch panel.

A vehicle driver or the like may wear anti-glare sunglasses using polarized lenses which let light oscillating in the longitudinal direction pass through and block light oscillating in the transverse direction. In the image display system 1X, meanwhile, a formed image is composed of light oscillating in the longitudinal direction (in an up-and-down direction). Thus, the image display system 1X can provide a user even wearing such sunglasses with a formed image having good visibility.

In the image display system 1X, an image is formed in a compartment of a vehicle. That is, the image display system 1X can form and display an image in a position suitable for each of one or more vehicle occupants.

### Second Embodiment

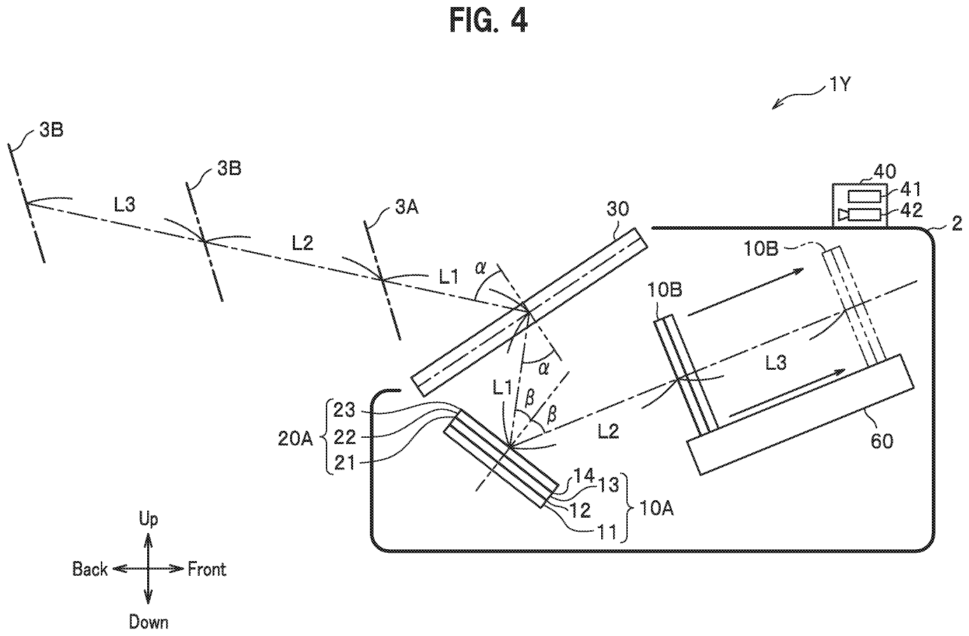

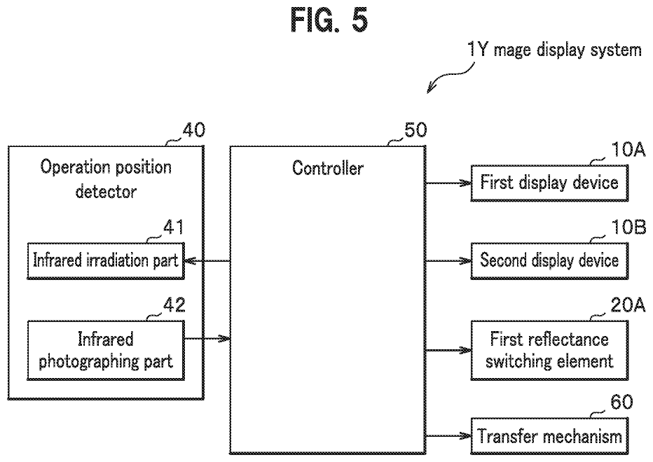

Next is described an image display system according to a second embodiment of the present invention, focusing on differences from the image display system 1X according to the first embodiment of the present invention. As illustrated in each of FIG. 4 and FIG. 5, an image display system 1Y according to the second embodiment has a structure similar to that of the first embodiment, except that the system 1Y further includes a transfer mechanism 60.

### <Transfer Mechanism>

The transfer mechanism 60 transfers, under control by the controller 50, the second display device 10B between a position at a distance L2 (a distance which an image light of interest travels) from the first reflectance switching element 20A and a position at a distance L2+L3 (a distance which an image light of interest travels) from the first reflectance switching element 20A.

### <Example of how System Works>

Next is described a change in an image forming position when the image 3B is formed and displayed, in an example of how the image display system 1Y works.

### <<Forming and Displaying Image 3B>>

When the image 3B is formed and displayed, the controller 50 controls the transfer mechanism 60, based on, for example, a result detected by the operation position detector 40, such that: the second display device 10B is transferred to a position desired by a user; and is then stopped at the desired position. The optical imaging member 30 forms the image 3B via the first reflectance switching element 20A in an aerial position at a distance not shorter than L1+L2 and not longer than L1+L2+L3 (a distance which an image light travels) from the optical imaging member 30.

The image display system 1Y can be installed in a front end portion in a vehicle length direction of a three-row seat compartment of a vehicle and a middle portion in a vehicle width direction thereof. In this case, the image display system 1Y: can form and display the image 3A in such a position that can be operated by a driver sitting in a driver's seat or an occupant sitting in a front passenger seat; and can form and display the image 3B in such a position that can be operated by an occupant sitting in a middle and a back passenger seat.

The image display system 1Y according to the second embodiment of the present invention can suitably change an image forming position of the image 3B. That is, the image display system 1Y can change an image forming and displaying position to any of different positions having different distances from the optical imaging member 30 (in this embodiment; any of a position at a distance L1, and a position between a distance L1+L2 and a distance L1+L2+L3).

### Third Embodiment

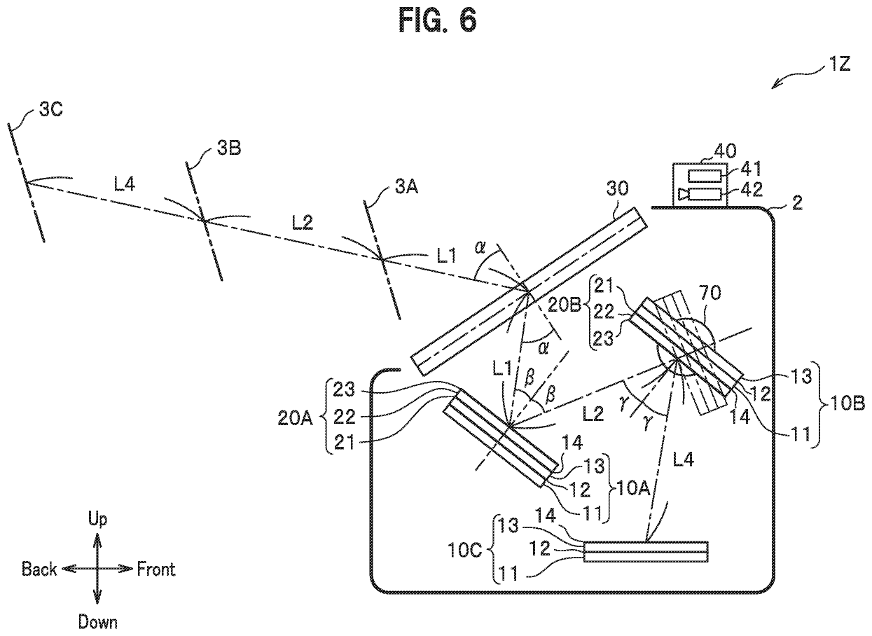

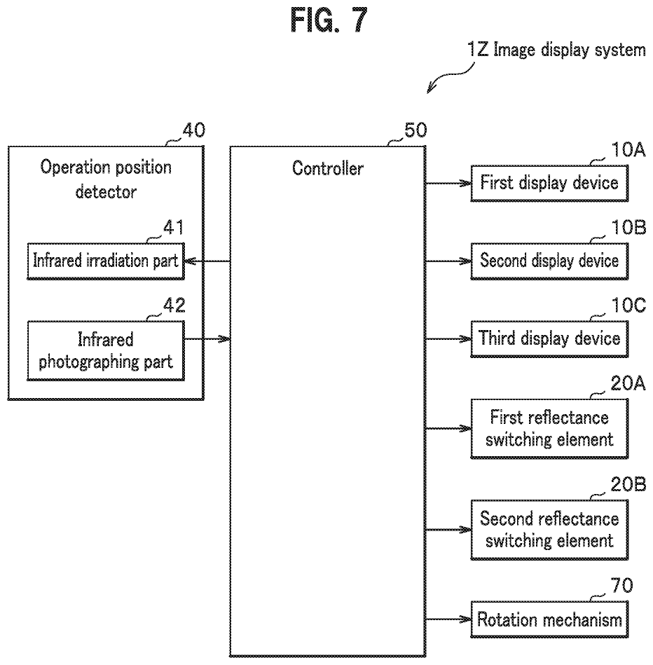

Next is described an image display system according to a third embodiment of the present invention, focusing on differences from the image display system 1X according to the first embodiment of the present invention. As illustrated in each of FIG. 6 and FIG. 7, an image display system 1Z according to the third embodiment has a structure similar to that of the first embodiment, except that the system 1Z further includes a third display device 10C, a second reflectance switching element 20B, and a rotation mechanism 70.

### <Third Display Device>

The third display device 100 is housed in the housing 2 and displays an image under control by the controller 50. The third display device 10C is oriented upward and is disposed below the second reflectance switching element 20B. A distance which an image light travels between the third display device 10C and the second reflectance switching element 20B is set to a distance L4. In this embodiment, the third display device 10C is an LCD (Liquid Crystal Display); and, similarly to the first display device 10A, includes a backlight 11, an absorptive polarizer 12, a liquid crystal cell 13, and an absorptive polarizer 14.

### <Second Reflectance Switching Element>

The second reflectance switching element 20B is housed in the housing 2 and, in this embodiment, is disposed on a side nearer to a display surface (a rear surface) of the second display device 10B. The second reflectance switching element 20B is an element which can electrically switch a state thereof between the reflection state and the transmission state as described above, under control of the controller 50. The second reflectance switching element 20B may be firmly attached to the second display device 10B, using optical coupling resin, tape, or the like. Alternatively, the second reflectance switching element 20B may be disposed spaced apart from the second display device 10B. The second reflectance switching element 20B includes a reflective polarizer 21, a liquid crystal cell 22, and an absorptive polarizer 23, in this order from front to back.

### <Rotation Mechanism>

The rotation mechanism 70 rotates, under control by the controller 50, the second display device 10B together with the second reflectance switching element 20B so as to take an appropriate position thereof between an attitude for forming and displaying the image 3B and an attitude for forming and displaying the image 3C. Herein, the image 3B is an image displayed by the second display device 10B; and the image 3C, by the third display device 10C.

### <Example of how System Works>

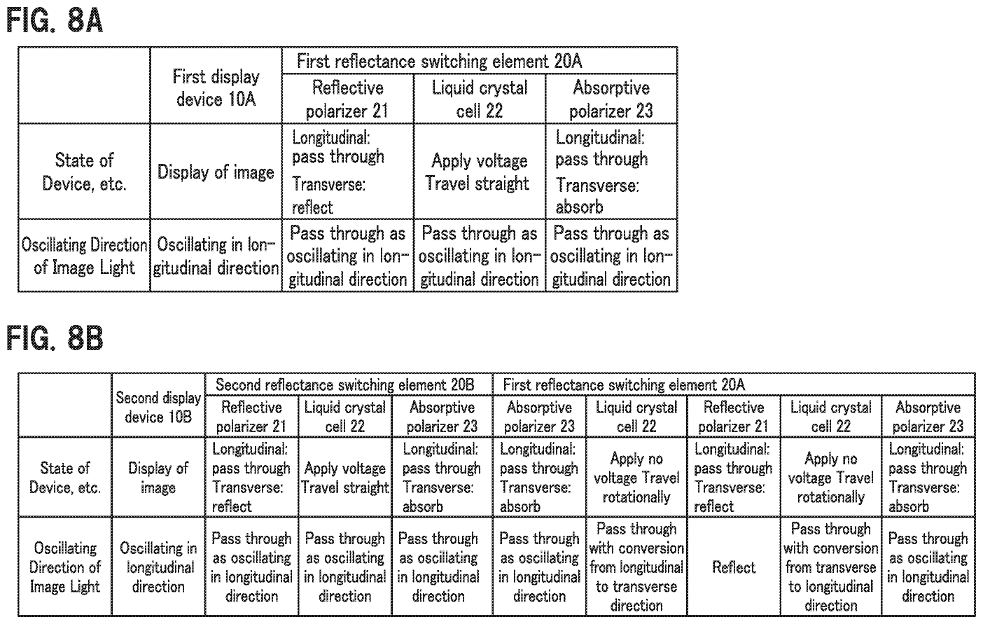

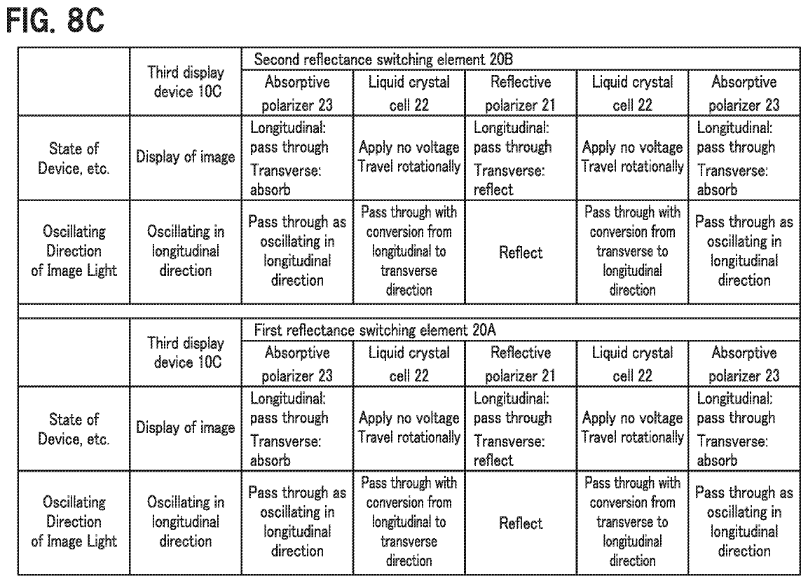

Next is described how the image display system 1Z works regarding: forming and displaying the image 3B; and forming and displaying the image 30. Description of forming and displaying the image 3A illustrated in FIG. 8A is substantially same as that in the example of how the image display system 1X works and is thus omitted herefrom.

### <<Forming and Displaying Image 3B>>

As illustrated in FIG. 8B, when the image 3B is formed and displayed, the controller 50 controls the rotation mechanism 70 such that the second display device 10B together with the second reflectance switching element 20B are rotated to take an appropriate attitude position thereof for forming and displaying the image 3B. Also, the controller 50: turns on the backlight 11 of the second display device 10B; applies voltage to the liquid crystal cell 13 of the second display device 10B and the liquid crystal cell 22 of the second reflectance switching element 20B. The controller 50 applies, however, no voltage to the liquid crystal cell 22 of the first reflectance switching element 20A.

In the second display device 10B, from among light emitted from the backlight 11, the absorptive polarizer 12; absorbs light oscillating in the transverse direction; and lets light oscillating in the longitudinal direction pass therethrough. The light oscillating in the longitudinal direction having passed through the absorptive polarizer 12 passes through the liquid crystal cell 13 as it is (as the light oscillating in the longitudinal direction). The light oscillating in the longitudinal direction having passed through the liquid crystal cell 13 passes through the absorptive polarizer 14.

The light oscillating in the longitudinal direction having passed through the absorptive polarizer 14 passes through the reflective polarizer 21 of the second reflectance switching element 20B. The light oscillating in the longitudinal direction having passed through the reflective polarizer 21 passes through the liquid crystal cell 22 as it is (as the light oscillating in the longitudinal direction). The light oscillating in the longitudinal direction having passed through the liquid crystal cell 22: passes through the absorptive polarizer 23; and exits to the first reflectance switching element 20A.

That is, in a state where voltage is applied, the second reflectance switching element 20B of the image display system 1X serves as a light transmission layer which lets light of the image 3A displayed in the first display device 10A pass through.

The light oscillating in the longitudinal direction having exited to the first reflectance switching element 20A passes through the absorptive polarizer 23 the first reflectance switching element 20A. The light oscillating in the longitudinal direction having passed through the absorptive polarizer 23 is, when passing downward through the liquid crystal cell 22, converted into light oscillating in the transverse direction. The light oscillating in the transverse direction having been converted by the liquid crystal cell 22 is reflected by the reflective polarizer 21 at a reflection angle 3. The light having been reflected by the reflective polarizer 21 is, when passing upward through the liquid crystal cell 22, converted into light oscillating in the longitudinal direction by the liquid crystal cell 22. The light oscillating in the longitudinal direction having been converted by the liquid crystal cell 22: passes through the absorptive polarizer 23: and exits to the optical imaging member 30.

That is, in a state where no voltage is applied, the first reflectance switching element 20A of the image display system 1Z serves as a mirror which reflects light of the image 3B displayed in the second display device 10B.

The optical imaging member 30 makes the image 3B via the second reflectance switching element 20B and the first reflectance switching element 20A refracted at the refracting angle α; and forms the refracted image 3B at a distance L1+L2 (a distance which an image light of interest travels) from the optical imaging member 30 in the air.

Note that, in forming and displaying the image 3B, the controller 50 may leave the image 3A displayed in the first display device 10A or the image 3C displayed in the third display device 10C, as it is. Alternatively, in forming and displaying the image 3B, the controller 50 may turn off the first display device 10A and/or the third display device 10C.

### <<Forming and Displaying Image 3C>>

As illustrated in FIG. 8C, when the image 3C is formed and displayed, the controller 50 controls the rotation mechanism 70 such that the second display device 10B together with the second reflectance switching element 20B are rotated to take an attitude position thereof for forming and displaying the image 30. Also, the controller 50: turns on the backlight 11 of the third display device 100; and applies voltage to the liquid crystal cell 13 of the third display device 10C. The controller 50 applies, however, no voltage to the respective liquid crystal cells 22 of the first reflectance switching element 20A and the second reflectance switching element 20B.

In the third display device 100, from among light emitted from the backlight 11, the absorptive polarizer 12: absorbs light oscillating in the transverse direction; and lets light oscillating in the longitudinal direction pass therethrough. The light oscillating in the longitudinal direction having passed through the absorptive polarizer 12 passes through the liquid crystal cell 13 as it is (as the light oscillating in the longitudinal direction). The light oscillating in the longitudinal direction having passed through the liquid crystal cell 13 passes through the absorptive polarizer 14.

The light oscillating in the longitudinal direction having passed through the absorptive polarizer 14 passes through the absorptive polarizer 23 of the second reflectance switching element 20B. The light oscillating in the longitudinal direction having passed through the absorptive polarizer 23 is, when passing upward through the liquid crystal cell 22, converted into light oscillating in the transverse direction. The light oscillating in the transverse direction having been converted by the liquid crystal cell 22 is reflected by the reflective polarizer 21 at a reflection angle γ. The light having been reflected by the reflective polarizer 21 is, when passing downward through the liquid crystal cell 22, converted into light oscillating in the longitudinal direction by the liquid crystal cell 22. The light oscillating in the longitudinal direction having been converted by the liquid crystal cell 22: passes through the absorptive polarizer 23; and exits to the first reflectance switching element 20A.

That is, in a state where voltage is applied, the second reflectance switching element 20B of the image display system 1Z serves as a mirror which reflects light of the image 3C displayed in the third display device 100.

Then, the light oscillating in the longitudinal direction having exited to the first reflectance switching element 20A passes through the absorptive polarizer 23 of the first reflectance switching element 20A. The light oscillating in the longitudinal direction having passed through the absorptive polarizer 23 is, when passing downward through the liquid crystal cell 22, converted into light oscillating in the transverse direction. The light oscillating in the transverse direction having been converted by the liquid crystal cell 22 is reflected by the reflective polarizer 21 at a reflection angle β. The light having been reflected by the reflective polarizer 21 is, when passing upward through the liquid crystal cell 22, converted into light oscillating in the longitudinal direction by the liquid crystal cell 22. The light oscillating in the longitudinal direction having been converted by the liquid crystal cell 22; passes through the absorptive polarizer 23; and exits to the optical imaging member 30.

That is, in the state where no voltage is applied, the first reflectance switching element 20A of the image display system 1Z serves as a mirror which reflects light of the image 3C displayed in the third display device 100.

The optical imaging member 30 makes the image 3C via the second reflectance switching element 20B and the first reflectance switching element 20A, refracted at the refracting angle α; and forms the refracted image 3B at a distance L1+L2+L4 (a distance which an image light of interest travels) from the optical imaging member 30 in the air.

Note that, in forming and displaying the image 30, the controller 50 may leave the image 3A displayed in the first display device 10A or the image 3B displayed in the second display device 10B, as it is. Alternatively, in forming and displaying the image 3C, the controller 50 may turn off the first display device 10A and/or the second display device 10B.

The image display system 1Z can be installed in a front end portion in a vehicle length direction of a three-row seat compartment of a vehicle and a middle portion in a vehicle width direction thereof. In this case, the image display system 1Z can form and display: the image 3A in such a position that can be operated by a driver sitting in a driver's seat or an occupant sitting in a front passenger seat; the image 3B, by an occupant sitting in a middle passenger seat; and, the image 3C, by an occupant sitting in a back passenger seat.

The image display system 1Z according to the third embodiment of the present invention can suitably form an image in three different positions having different distances from the optical imaging member 30. In other words, the image display system 1Z can change a position in which an image is formed and displayed, to any of a plurality of different positions having distances different from each other with respect to the optical imaging member 30 (in this embodiment, three different positions).

The present invention has been described above with reference to the embodiments thereof, though the present invention is not limited to those embodiments, and various changes are possible within a scope not departing from the gist of the present invention. For example, an image display system of the present invention may include a manipulation part by which a driver can manipulate an image and may have a configuration such that the controller makes one or more display devices display an image created based on a result of manipulation by the manipulation part.

As an embodiment for reference of the present invention, a display device can be realized by combining a light source and a celluloid picture. An image display system of the present invention can be applied not only to a vehicle but also to a game console, a poster, a guideboard, touch panels of various types, and the like.

A structure of each of the first reflectance switching element 20A and the second reflectance switching element 20B is not limited to that described above. That is, a variety of elements which are switchable between a reflection state in which light is reflected thereby and a transmission state in which light passes therethrough (for example, a variable reflectance element described in WO 2015/093298) can be used as the first reflectance switching element 20A and the second reflectance switching element 20B.

The operation position detector 40 is not limited to the one which detects a position of a user's finger by means of infrared rays. The operation position detector 40 may be a detector which detects a position of the user's finger by using, for example, a visible light, a sound wave, or the like.

### DESCRIPTION OF REFERENCE NUMERALS

1X, 1Y, 1Z image display system
10A first display device
10B second display device
10C third display device
20A first reflectance switching element
20B second reflectance switching element
30 optical imaging member
40 operation position detector
50 controller

1. An image display system, comprising:
a first display device and a second display device, each of which displays an image:
an optical imaging member that is disposed spaced apart from each of the first display device and the second display device and that forms an image displayed in the first display device or the second display device, in respective positions different from each other in the air; and
a reflectance switching element that is switchable between a transmission state and a reflection state,
wherein light of the image displayed in the first display device passes through the reflectance switching element and is then made incident on the optical imaging member, to thereby form the image of interest in the air, and
wherein light of the image displayed in the second display device is reflected by the reflectance switching element and is then made incident on the optical imaging member, to thereby form the image of interest in the air.

2. The image display system according to claim 1,
wherein the image displayed in the first display device is formed at a first distance from the optical imaging member,
wherein the image displayed in the second display device is formed at a second distance which is different from the first distance, from the optical imaging member,
wherein the first distance is a distance between the first display device and the optical imaging member, and
wherein the second distance is a distance obtained by summing up a distance between the second display device and the reflectance switching element and a distance between the reflectance switching element and the optical imaging member.

3. The image display system according to claim 1,
further comprising a controller that provides control over the first display device, the second display device, and the reflectance switching element,
wherein, in a state in which the image is displayed in the first display device, the controller: makes the reflectance switching element take the transmission state; thereby lets light of the image displayed in the first display device pass through the reflectance switching element; makes the passing-through light incident on the optical imaging member; and makes the optical imaging member form the image of interest, and
wherein, in a state in which the image is displayed in the second display device, the controller: makes the reflectance switching element take the reflection state; makes light displayed in the second display device reflect by reflectance switching element; makes the reflected light incident on the optical imaging member; and makes the optical imaging member form the image of interest.

4. The image display system according to claim 3,
further comprising an operation position detector that detects a position of an operation by a user in a position in which the image is formed,
wherein the controller controls the first display device and the second display device, based on a result detected by the operation position detector.

5. The image display system according to claim 1,
wherein the image formed by the optical imaging member is composed of light oscillating in a longitudinal direction.

6. The image display system according to claim 1,
wherein the image display system is installed in a vehicle and the image is formed in a compartment of the vehicle.

7. The image display system according to claim 2,
further comprising a controller that provides control over the first display device, the second display device, and the reflectance switching element,
wherein, in a state in which the image is displayed in the first display device, the controller: makes the reflectance switching element take the transmission state; thereby lets light of the image displayed in the first display device pass through the reflectance switching element; makes the passing-through light incident on the optical imaging member; and makes the optical imaging member form the image of interest, and
wherein, in a state in which the image is displayed in the second display device, the controller: makes the reflectance switching element take the reflection state; makes light displayed in the second display device reflect by the reflectance switching element; makes the reflected light incident on the optical imaging member; and makes the optical imaging member form the image of interest.

8. The image display system according to claim 7,
further comprising an operation position detector that detects a position of an operation by a user in a position in which the image is formed,
wherein the controller controls the first display device and the second display device, based on a result detected by the operation position detector.

9. The image display system according to claim 2,
wherein the image formed by the optical imaging member is composed of light oscillating in a longitudinal direction.

10. The image display system according to claim 3,
wherein the image formed by the optical imaging member is composed of light oscillating in a longitudinal direction.

11. The image display system according to claim 4,
wherein the image formed by the optical imaging member is composed of light oscillating in a longitudinal direction.

12. The image display system according to claim 7,
wherein the image formed by the optical imaging member is composed of light oscillating in a longitudinal direction.

13. The image display system according to claim 8,
wherein the image formed by the optical imaging member is composed of light oscillating in a longitudinal direction.

14. The image display system according to claim 2,
wherein the image display system is installed in a vehicle and the image is formed in a compartment of the vehicle.

15. The image display system according to claim 3,
wherein the image display system is installed in a vehicle and the image is formed in a compartment of the vehicle.

16. The image display system according to claim 4,
wherein the image display system is installed in a vehicle and the image is formed in a compartment of the vehicle.
